(19) United States
(12) Patent Application Publication
(10) Pub. No.: US 2013/0061090 A1
(43) Pub. Date: Mar. 7, 2013

(54) PARTIAL REBOOTING RECOVERY APPARATUS AND METHOD

(71) Applicant: Kwang Yong LEE, Daejeon (KR)

(72) Inventor: Kwang Yong LEE, Daejeon (KR)

(73) Assignee: ELECTRONICS AND TELECOMMUNICATIONS RESEARCH INSTITUTE, Daejeon (KR)

(21) Appl. No.: 13/603,848

(22) Filed: Sep. 5, 2012

(30) Foreign Application Priority Data
Sep. 6, 2011 (KR) 10-2011-0090088

(51) Int. Cl. G06F 11/14

(52) U.S. Cl. 714/16; 714/E11.133

(57) ABSTRACT

A partial rebooting recovery apparatus is provided. The partial rebooting recovery apparatus may store a system state of a predetermined booting point in time, may receive a failure signal of a system, may call a failure recovery processing function, may recover the system to the system state of the predetermined booting point in time, based on the failure signal, and may reboot the system from a point in time at which the system is recovered.

### CROSS-REFERENCE TO RELATED APPLICATION

This application claims the benefit of Korean Patent Application No. 10-2011-0090088, filed on Sep. 6, 2011, in the Korean Intellectual Property Office, the disclosure of which is incorporated herein by reference.

### BACKGROUND

1. Field of the Invention

The present invention relates to a rebooting recovery apparatus and method, and more particularly, to an apparatus and method for recovering a failure occurring in a computer.

2. Description of the Related Art

To reboot a computing device, the computing device may be powered on immediately after the computing device is powered off. Accordingly, a central processing unit (CPU) and auxiliary devices may be operated again in a hardware manner, and all data remaining in a random-access memory (RAM) may disappear.

When an error occurs, an embedded system with a special purpose function may use a scheme of automatically rebooting a system using a system reset function to solve the error.

For example, when a serious error occurs in an application, a smartphone may not respond to a touch or button input, and an initial booting logo may appear on a screen. In this example, when a predetermined period of time elapses, a system may be restarted.

However, a long period of time may be required to reboot the smartphone, to escape from the error and to restart the system. In this instance, since users wait for a long period of time to use smartphones, the users may determine that a failure occurs in smartphones. Additionally, reliability of a quality of a system may be reduced.

### SUMMARY

According to an aspect of the present invention, there is provided a partial rebooting recovery apparatus, including: a booting state storage unit to store a system state of a predetermined booting point in time; a system failure monitoring unit to receive a failure signal of a system, and to call a failure recovery processing function; and a system recovering to unit to recover the system to the system state of the predetermined booting point in time, based on the failure signal, and to perform rebooting from a point in time at which the system is recovered.

The partial rebooting recovery apparatus may further include a main storage unit including a first memory area to store an image of the system state of the predetermined booting point in time, and a second memory area to execute an operating system (OS) of the system and an application of the system.

When a partial rebooting interrupt occurs in the system, the system recovering unit may recover the system to the system state of the predetermined booting point in time, may initialize a kernel in two stages from the point in time at which the system is recovered, may initialize a user area, and may execute an application or a main player.

The system failure monitoring unit may include an OS executing unit to permit a SIGKILL signal, the OS executing unit being operated as a kernel thread, a kernel managing unit to enable an interrupt, an interrupt determining unit to determine whether a rebooting interrupt of the system exists, and a system rebooting unit to reboot the system from the point in time at which the system is recovered, when the rebooting interrupt is determined to exist.

The booting state storage unit may store a register value and a state of a central processing unit (CPU) in a predetermined point during a kernel boot process, and may store a storage history of a used area of an entire storage space.

The booting state storage unit may include a marking point setting unit to mark the predetermined point and to set a marking point.

The system recovering unit may control data copied to an upper address of a memory to be recopied to a lower address, may jump to the marking point, and may reboot the system.

According to another aspect of the present invention, there is provided a partial rebooting recovery method, including: storing a system state of a predetermined booting point in time; receiving a failure signal of a system, and calling a failure recovery processing to function; recovering the system to the system state of the predetermined booting point in time, based on the failure signal; and rebooting the system from a point in time at which the system is recovered.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a computing system including a partial rebooting recovery apparatus according to an embodiment of the present invention;

FIG. 2 is a flowchart illustrating a partial rebooting recovery method according to an embodiment of the present invention;

FIG. 3 is a flowchart illustrating an example of executing a partial rebooting recovery agent according to an embodiment of the present invention;

FIG. 4 is a flowchart illustrating a scheme of storing a recovery image in a partial rebooting recovery apparatus according to an embodiment of the present invention; and

FIG. 5 is a flowchart illustrating a scheme of recovering a system to an intermediate stage of booting based on a failure signal and of rebooting the system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

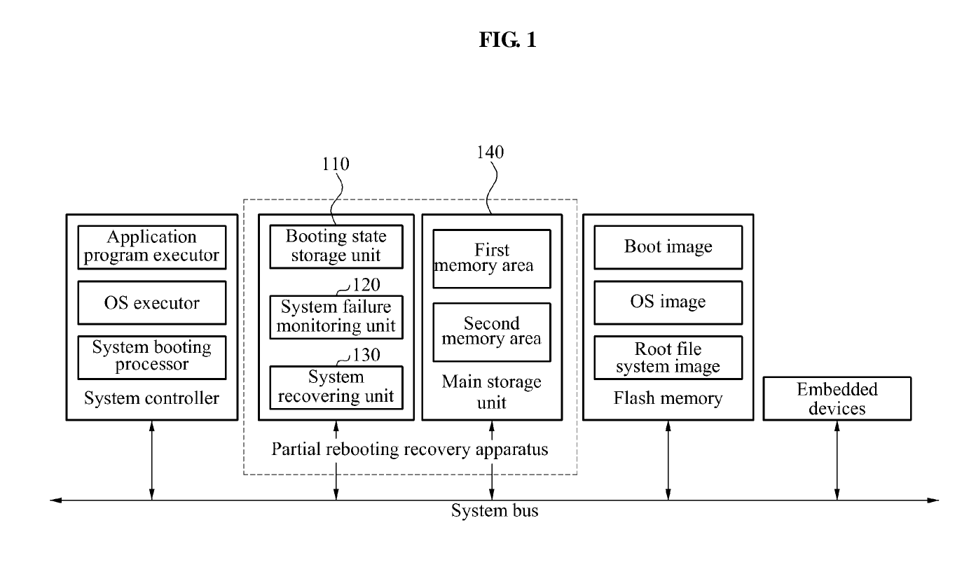

FIG. 1 is a block diagram illustrating a computing system including a partial rebooting recovery apparatus according to an embodiment of the present invention.

Referring to FIG. 1, the partial rebooting recovery apparatus may include a booting state storage unit 110, a system failure monitoring unit 120, and a system recovering unit 130. The booting state storage unit 110 may store a system state of a predetermined booting point in time. The system failure monitoring unit 120 may receive a failure signal of a system, and may call a failure recovery processing function. The system recovering unit 130 may recover the system to the system state of the predetermined booting point in time, and may perform rebooting from a point in time at which the system is recovered.

The partial rebooting recovery apparatus may further include a main storage unit 140 that is divided into a first memory area to store an image of the system state of the predetermined booting point in time, and a second memory area to execute an operating system (OS) of the system and an application of the system.

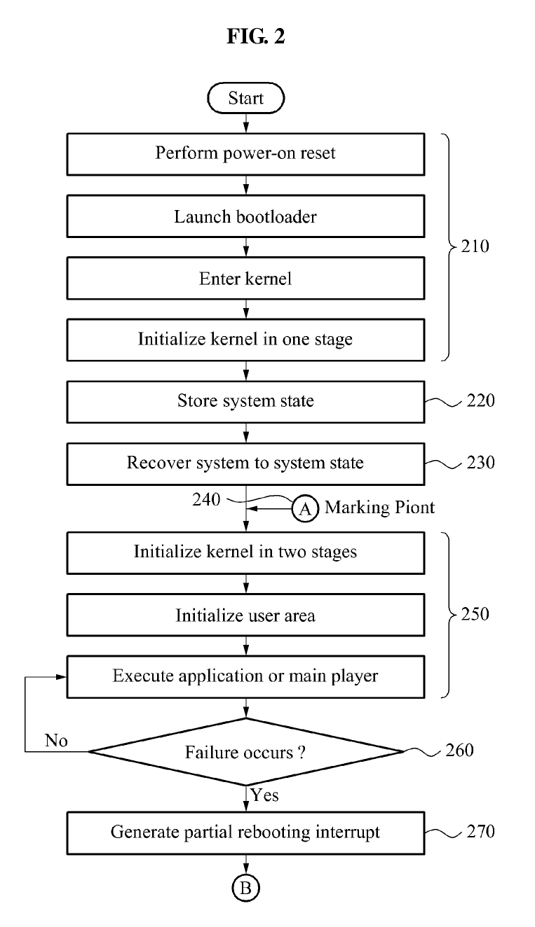

FIG. 2 is a flowchart illustrating a partial rebooting recovery method according to an embodiment of the present invention.

When a power source is connected to a partial rebooting recovery apparatus according to an embodiment of the present invention, that is, when power-on reset is performed, the power source and a system clock may be stabilized, and a central processing unit (CPU) may be operated.

The CPU may be operated for a period from tens of milliseconds to a few seconds, based on hardware characteristics.

The computing system may launch a bootloader, and may initialize hardware required for a system operation, a device and hardware to be used by the computing system. Subsequently, the computing system may prepare kernel booting, and may pass a system control right to a kernel.

The computing system may enter the kernel. In this instance, when the kernel is compressed, the computing system may decompress the kernel.

In operation 210, the computing system may initialize the kernel to the first.

In operation 220, the partial rebooting recovery apparatus may store a system state of a predetermined booting point in time.

According to an aspect of the present invention, the booting state storage unit 110 may store a register value and a state of a CPU in a predetermined point during a kernel boot process, and may store a storage history of a used area of an entire storage space.

In this instance, when a partial rebooting interrupt occurs in the system, the system recovering unit 130 may recover the system to the system state of the predetermined booting point in time in operation 230.

The booting state storage unit 110 may include a marking point setting unit. The marking point setting unit may mark the predetermined point, and may set a marking point in operation 240.

In operation 250, the system recovering unit 130 may initialize the kernel to the second from a point in time at which the system is recovered, may initialize a user area, and may execute an application or a main player.

In operation 260, the partial rebooting recovery apparatus may determine whether a failure occurs in the system. When the failure is determined to occur, the partial rebooting recovery apparatus may generate a partial rebooting interrupt, and may perform a booting intermediate state recovery function in operation 270.

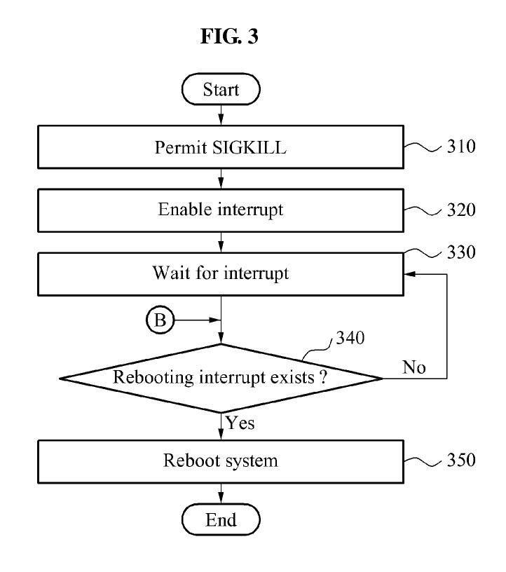

FIG. 3 is a flowchart illustrating an example of executing a partial rebooting recovery agent according to an embodiment of the present invention.

Referring to FIG. 3, the system failure monitoring unit 120 may be operated as a kernel thread, using an OS executing unit.

In operation 310, the system failure monitoring unit 120 may permit a SIGKILL signal in the thread. When the system operated as the kernel thread, the system failure monitoring unit 120 may enable an interrupt using a kernel managing unit in operation 320, and may wait for the interrupt in operation 330.

In operation 340, the system failure monitoring unit 120 may determine whether a rebooting interrupt of the system exists, by using an interrupt determining unit.

When the rebooting interrupt is determined to exist, the system failure monitoring unit 120 may reboot the system from the point in time at which the system is recovered, using a system rebooting unit in operation 350.

The system recovering unit 130 may control data copied to an upper address of a memory to be recopied to a lower address, may jump to the marking point, and may reboot the system.

The partial rebooting recovery apparatus may store, in a specific area of the memory, a register value and a state of a CPU in a specific point during the kernel boot process, and a used area of an entire memory space.

The partial rebooting recovery apparatus may mark, in advance, the specific point, and may enable the system to be recovered when partial booting is performed.

To recover the system, the partial rebooting recovery apparatus may set, in advance, a specific address of the system as a partial booting marking point.

For example, the marking point may be included in an ‘init/main.c’ file.

The partial rebooting recovery apparatus may set a marking point at a point in time before mounting a root after a do_basic_setup function in a kernel_init function, and may call a function used to copy, in advance, data to the memory in the marking point.

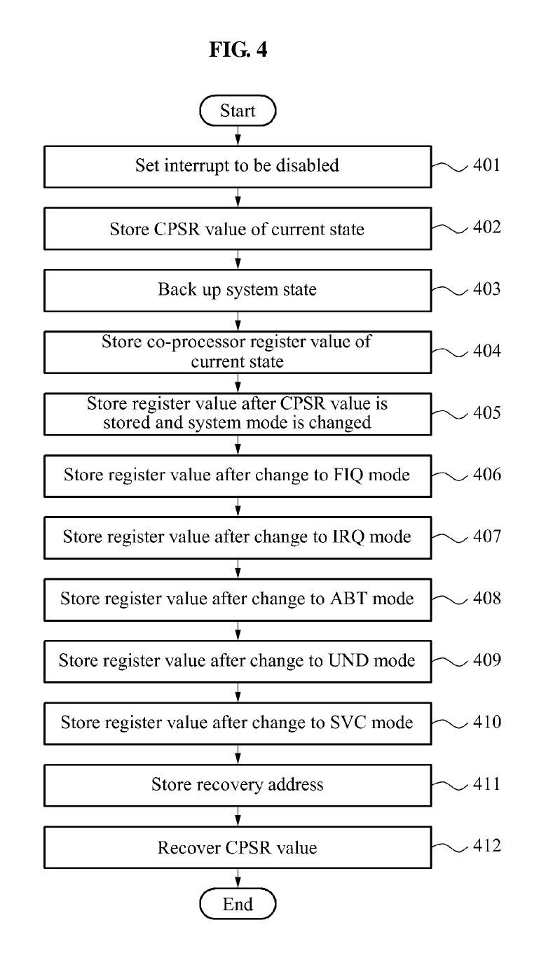

The partial rebooting recovery apparatus may store a recovery image through a code implementation process of FIG. 4.

FIG. 4 is a flowchart illustrating a scheme of storing a recovery image in a partial rebooting recovery apparatus according to an embodiment of the present invention.

Referring to FIG. 4, in operation 401, the partial rebooting recovery apparatus may set an interrupt to be disabled.

The partial rebooting recovery apparatus may store a current program status register (CPSR) value in a current state in operation 402, and may back up the system state of the predetermined booting point in time in operation 403.

The partial rebooting recovery apparatus may store a co-processor register value in the current state in operation 404, and may store a register value after the CPSR value is stored and a system mode is changed in operation 405.

The partial rebooting recovery apparatus may store a register value after the system mode is changed to a fast interrupt request (FIQ) mode in operation 406, and may store a register value after the system mode is changed to an interrupt request (IRQ) mode in operation 407.

The partial rebooting recovery apparatus may store a register value after the system mode is changed to an active binding technology (ABT) mode in operation 408, and may store a register value after the system mode is changed to an undefined (UND) mode in operation 409.

The partial rebooting recovery apparatus may store a register value after the system mode is changed to a supervisor call (SVC) mode in operation 410, and may store a recovery address of the system in operation 411.

In operation 412, the partial rebooting recovery apparatus may recover the CPSR value, and may return an interrupt function to a called point.

The partial rebooting recovery apparatus may search for a backup memory area, using a scheme below.

The partial rebooting recovery apparatus may clear all memory space to be “0” before loading a kernel, may boot the kernel, and may check a memory per a 1 megabyte (MB) immediately before backup of the memory. When all data is “0” in an area of 1 MB, partial rebooting recovery apparatus may determine that the memory space is not used in booting of the kernel, and may not store the data.

When even 1 bit is set as “1”, the partial rebooting recovery apparatus may store a corresponding area of 1 MB in the backup memory area.

For example, a bootloader of the partial rebooting recovery apparatus has a size of 2 MB from an area of 62 MB (0xF80000*4=62 MB), all areas other than an area of 2 MB may be enabled to be “0.”

Since a memory check routine is executed immediately before data is stored, the partial rebooting recovery apparatus may track a memory area that is not used in a unit of 1 MB.

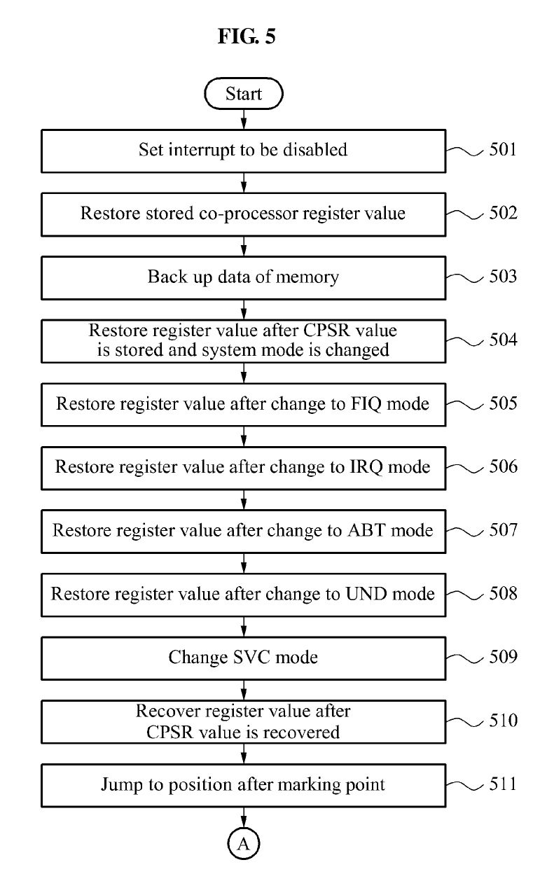

FIG. 5 is a flowchart illustrating a scheme of recovering a system to an intermediate stage of booting based on a failure signal and of rebooting the system according to an embodiment of the present invention.

A partial rebooting recovery apparatus according to an embodiment of the present invention may control data copied to an upper address of a memory to be recopied to a lower address, may jump to a marking point, and may reboot the system.

For example, the partial rebooting recovery apparatus may copy data in a memory area of 9 MB {0x22370000˜0x22400000} to each of memory areas {0x20000000˜0x205FFFFF (6 MB), 0x22C00000˜0x22CFFFFF (1 MB), 0x23000000˜0x231FFFFF (2 MB)}, and may restore an image.

Referring to FIG. 5, the partial rebooting recovery apparatus may restore the system, by implementing codes in the following order:

First, the partial rebooting recovery apparatus may set an interrupt to be disabled in operation 501, and may restore a stored co-processor register value in operation 502.

Subsequently, the partial rebooting recovery apparatus may restore data of the memory in operation 503, and may restore a register value after a CPSR value is stored and a system mode is changed in operation 504.

The partial rebooting recovery apparatus may restore a register value after the system mode is changed to an FIQ mode in operation 505, and may restore a register value after the system mode is changed to an IRQ mode in operation 506.

The partial rebooting recovery apparatus may restore a register value after the system mode is changed to an ABT mode in operation 507, and may restore a register value after the system mode is changed to an UND mode in operation 508.

The partial rebooting recovery apparatus may change an SVC mode in operation 509, and may recover a register value after the CPSR value is recovered in operation 510.

The partial rebooting recovery apparatus may recover the system to a marking point of the SVC mode, and may jump to a position after the marking point in operation 511.

According to embodiments of the present invention, a partial rebooting recovery method may perform rebooting at an intermediate point in time, compared to full booting or cold booting that is performed from a point in time at which power is applied to a system, and thus it is possible to quickly recover the system.

Additionally, according to embodiments of the present invention, a partial rebooting recovery method may store only a used area as a state image, and thus it is possible to store an image of an intermediate stage of booting, using a minimum size of a memory.

Furthermore, according to embodiments of the present invention, a partial rebooting recovery method may store an image for recovery in the same random-access memory (RAM), and thus it is possible to store data, without using a permanent storage device, such as a NAND flash memory or a disc.

Moreover, according to embodiments of the present invention, an intermediate state of a system may be stored in an intermediate stage of booting or rebooting, and the system may be recovered to the stored intermediate state upon occurrence of a system failure.

In addition, according to embodiments of the present invention, rebooting may be performed from a point in time at which a system is recovered, and thus it is possible to quickly escape from a system failure.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), RAM, flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A partial rebooting recovery apparatus, comprising:
a booting state storage unit to store a system state of a predetermined booting point in time;
a system failure monitoring unit to receive a failure signal of a system, and to call a failure recovery processing function; and
a system recovering unit to recover the system to the system state of the predetermined booting point in time, based on the failure signal, and to perform rebooting to from a point in time at which the system is recovered.

2. The partial rebooting recovery apparatus of claim 1, further comprising:
a main storage unit comprising a first memory area to store an image of the system state of the predetermined booting point in time, and a second memory area to execute an operating system (OS) of the system and an application of the system.

3. The partial rebooting recovery apparatus of claim 1, wherein, when a partial rebooting interrupt occurs in the system, the system recovering unit recovers the system to the system state of the predetermined booting point in time, initializes a kernel in two stages from the point in time at which the system is recovered, initializes a user area, and executes an application or a main player.

4. The partial rebooting recovery apparatus of claim 1, wherein the system failure monitoring unit comprises:
an OS executing unit to permit a SIGKILL signal, the OS executing unit being operated as a kernel thread;
a kernel managing unit to enable an interrupt;
an interrupt determining unit to determine whether a rebooting interrupt of the system exists; and
a system rebooting unit to reboot the system from the point in time at which the system is recovered, when the rebooting interrupt is determined to exist.

5. The partial rebooting recovery apparatus of claim 1, wherein the booting state storage unit stores a register value and a state of a central processing unit (CPU) in a predetermined point during a kernel boot process, and stores a storage history of a used area to of an entire storage space.

6. The partial rebooting recovery apparatus of claim 5, wherein the booting state storage unit comprises:
a marking point setting unit to mark the predetermined point and to set a marking point.

7. The partial rebooting recovery apparatus of claim 6, wherein the system recovering unit controls data copied to an upper address of a memory to be recopied to a lower address, jumps to the marking point, and reboots the system.

8. A partial rebooting recovery method, comprising:
storing a system state of a predetermined booting point in time;
receiving a failure signal of a system, and calling a failure recovery processing function;
recovering the system to the system state of the predetermined booting point in time, based on the failure signal; and
rebooting the system from a point in time at which the system is recovered.

9. The partial rebooting recovery method of claim 8, wherein the rebooting comprises:
recovering the system to the system state of the predetermined booting point in time, and initializing a kernel in two stages from the point in time at which the system is recovered, when a partial rebooting interrupt occurs in the system;
initializing a user area; and
executing an application or a main player.

10. The partial rebooting recovery method of claim 8, wherein the rebooting comprises:
permitting a SIGKILL signal, using a kernel thread;
enabling an interrupt, when a task of the kernel thread is executed;
determining whether a rebooting interrupt of the system exists; and
rebooting the system from the point in time at which the system is recovered, when the rebooting interrupt is determined to exist.

11. The partial rebooting recovery method of claim 8, wherein the storing comprises:
storing a register value and a state of a central processing unit (CPU) in a predetermined point during a kernel boot process; and
storing a storage history of a used area of an entire storage space.

12. The partial rebooting recovery method of claim 11, wherein the storing comprises:
marking the predetermined point and setting a marking point.

13. The partial rebooting recovery method of claim 8, wherein the storing comprises:
setting an interrupt to be disabled;
storing a current program status register (CPSR) value of a current state;
backing up the system state of the predetermined booting point in time;
storing a co-processor register value of the current state;
storing a register value after the CPSR value is stored and a system mode is changed;
storing a register value after the system mode is changed to a fast interrupt request (FIQ) mode;
storing a register value after the system mode is changed to an interrupt request (IRQ) mode;
storing a register value after the system mode is changed to an active binding technology (ABT) mode;
storing a register value after the system mode is changed to an undefined (UND) mode;
storing a register value after the system mode is changed to a supervisor call (SVC) mode;
storing a recovery address of the system;
recovering the CPSR value; and
returning an interrupt function to a called point.

14. The partial rebooting recovery method of claim 12, wherein the rebooting comprises:
controlling data copied to an upper address of a memory to be recopied to a lower address; and
jumping to the marking point, and rebooting the system.

15. The partial rebooting recovery method of claim 14, wherein the rebooting comprises:
setting an interrupt to be disabled;
restoring a stored co-processor register value;
restoring data of a memory;
restoring a register value after a CPSR value is stored and a system mode is changed;
restoring a register value after the system mode is changed to an FIQ mode;
restoring a register value after the system mode is changed to an IRQ mode;
restoring a register value after the system mode is changed to an ABT mode;
restoring a register value after the system mode is changed to an UND mode;
changing an SVC mode;
recovering a register value after the CPSR value is recovered;
recovering the system to a marking point of the SVC mode; and
jumping to a position after the marking point.
